(19) United States
(12) Patent Application Publication
(10) Pub. No.: US 2024/0386247 A1
(43) Pub. Date: Nov. 21, 2024

(54) CONSISTENCY EVALUATION FOR DOCUMENT SUMMARIES USING LANGUAGE MODEL NEURAL NETWORKS

(71) Applicant: Google LLC, Mountain View, CA (US)

(72) Inventors: Zorik Gekhman, Haifa (IL); Jonathan Herzig, Tel Aviv (IL); Roee Aharoni, Tel Aviv (IL); Idan Szpektor, Kfar Saba (IL)

(21) Appl. No.: 18/668,086

(22) Filed: May 17, 2024

Related U.S. Application Data
(60) Provisional application No. 63/467,568, filed on May 18, 2023.

(51) Int. Cl. G06N 3/0455

(52) U.S. Cl. CPC G06N 3/0455

(57) ABSTRACT

Methods, systems, and apparatus, including computer programs encoded on computer storage media, for generating, using a language model, a data set for use in performing consistency evaluation for document summaries. For example, the data set can be used to train or evaluate a consistency evaluation neural network.

### CROSS-REFERENCE TO RELATED APPLICATION

This application claims priority to U.S. Provisional Application No. 63/467,568, filed on May 18, 2023. The disclosure of the prior application is considered part of and is incorporated by reference in the disclosure of this application.

### BACKGROUND

This specification relates to processing text using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that generates a data set that includes multiple training examples.

Each training example includes (i) content from a corresponding document, e.g., text from the document or multi-modal content from the document that includes both images and text, (ii) a summary of the document, e.g., a text summary of the document, and (iii) an output that rates the consistency of the summary with the document.

Particular embodiments of the subject matter described in this specification can be implemented so as to realize one or more of the following advantages.

Summarizing the content of text or multi-modal documents is an important problem that has applicability in a wide variety of real-world tasks, e.g., for summarizing text documents that appear on the Internet, summarizing transcripts or multi-modal content from audio or video calls, or summarizing transcripts or multi-modal content from videos available on video sharing platforms.

Generative summarization models tend to provide more informative and more interesting document summaries than extractive summarization models because generative summarization models generate abstractive summaries that are not restricted to use only words from the original document.

In other words, the abstractive summaries that are generated by the models can rephrase or reformulate concepts from the source document and can frequently include terminology that is not present in the source document. This can be advantageous because a summary that summarizes or paraphrases document content using different language can be more informative and more interesting to users than one that attempts to merely remove less important content from the original document.

However, because generative summarization models “generate” the summary using potentially different language than the underlying document, these generative summarization models, i.e., machine learning models trained to generate summaries of documents, are prone to generate factually inconsistent summaries, which hampers the use of such models in domains where factual consistency is important.

Natural Language Inference models are commonly used for evaluating factual consistency, but exhibit limited success in evaluating the consistency of longer, natural language summaries such as those generated by generative summarization models.

Existing techniques have improved such models using synthetic training data, generated by perturbing human-written summaries. However, these perturbed summaries often differ in their characteristics from actual model-generated summaries and have limited coverage of possible factual errors that can be made by a generative summarization model.

Alternatively, large language models (LLMs) may be a powerful tool for evaluating generative tasks, but are too computationally expensive for practical use, e.g., cannot be used at inference time to determine whether a given model-generated summary is consistent with the underlying document (and therefore should be presented to a user) due to excessive latency or resource consumption.

Motivated by these limitations, the described techniques generate synthetic data by annotating diverse model-generated summaries using a language model neural network, e.g., an LLM. The described techniques do not require rule-based perturbations or human-written summaries and are multilingual by nature. In fact, a student consistency evaluation model trained using a data set generated by the described techniques substantially outperforms both a state-of-the art model with similar capacity, and the LLM teacher used to generate the data set despite being significantly more computationally efficient.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example data set generation system.

FIG. 2 is a flow diagram of an example process for generating a data set.

FIG. 3 shows the operation of the system.

FIG. 4 shows an example of the data generation process performed by the system.

FIG. 5 shows an example of the performance of the described techniques.

Like reference numbers and designations in the various drawings indicate like elements.

### DETAILED DESCRIPTION

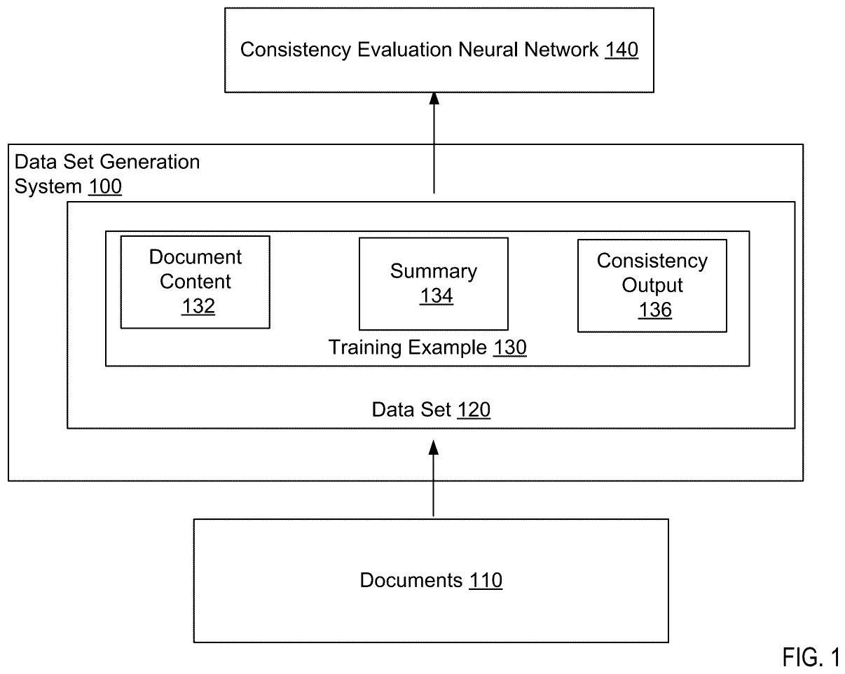

FIG. 1 shows an example data set generation system 100. The data set generation system 100 is an example of a system implemented as computer programs on one or more computers in one or more locations, in which the systems, components, and techniques described below can be implemented.

The system 100 receives a set of documents 110 and generates a data set 120 that includes multiple training examples 130.

The documents 110 each generally include content, e.g., text content or multi-modal content that includes text and content of one or more other modalities, e.g., video, audio, or images.

Each training example 130 in the data set 120 includes (i) document content 132 from a corresponding document 110, e.g., text from the document or multi-modal content from the document that includes both images and text, (ii) a summary 134 of the document 110, e.g., a text summary of the document 110, and (iii) a consistency output 136 that rates the consistency of the summary 134 with the document 110.

The consistency of a summary with a corresponding document generally refers to whether there are any inconsistencies between the facts in the summary and the facts in the document.

If all of the facts in the summary are consistent with the facts in the document, the summary is said to be consistent with the document. However, if more than a threshold number of facts in the summary are inconsistent with the facts in the document, the summary is said to be inconsistent with the document.

In some cases, the threshold can be zero, so that if any facts in the summary are inconsistent with the facts in the document, the summary is said to be inconsistent with the document.

If the threshold is greater than zero but the number of facts in the summary that are inconsistent with facts in the document is greater than zero but less than or equal to the threshold, the summary can be said to be consistent with the document or the consistency evaluation can be said to be inconclusive.

A fact in the summary is said to be consistent with the facts in the document where the fact in the summary agrees with the facts in the document. That is, given the facts in the document, the fact in the summary is understood to be accurate.

Once generated, the system 100 can use the data set 120 for any of a variety of purposes.

For example, the system 100 can use the data set 120 as training data for a consistency evaluation neural network 140.

As another example, the system 100 can use the data set to evaluate the performance of the consistency evaluation neural network 140 after training.

The consistency evaluation neural network 140 is a neural network that is configured to receive an input that includes content from an input document and an input summary of the input document and generate an output that rates the consistency of the input summary with the input document. For example, the consistency evaluation neural network 140 can have an encoder-decoder Transformer architecture or a decoder-only Transformer architecture.

When the system 100 uses the data set 120 to train the neural network 140, for each training example 130, the system 100 can use the consistency output in the training example 130 as a target output for the consistency evaluation neural network 140.

When the system 100 uses the data set 120 to evaluate the neural network 140 after training, for each training example 130, the system 100 can measure the performance of the neural network 140 based on an error between the output generated by the neural network 140 and the consistency output in the training example 130.

By using the data set 120 to train the neural network 140, e.g., from scratch or for fine-tuning, the system 100 can cause the neural network 140 to accurately evaluate the factual consistency of summaries in a computationally-efficient manner.

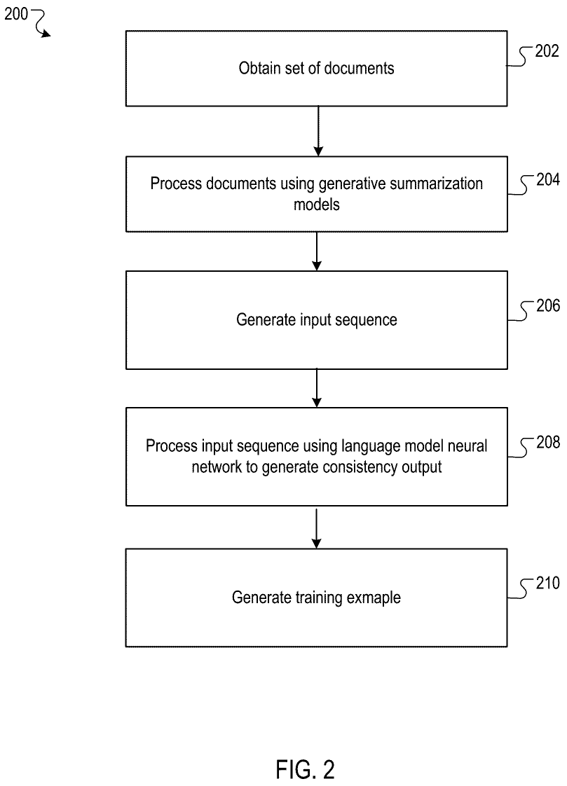

Generating the data set 120 is described in more detail below with reference to FIGS. 2-4.

FIG. 2 is a flow diagram of an example process 200 for generating a data set. For convenience, the process 200 will be described as being performed by a system of one or more computers located in one or more locations. For example, a data set generation system, e.g., the data set generation system 100 of FIG. 1, appropriately programmed, can perform the process 200.

The system obtains a set of documents (step 202). Advantageously, although the data set will include summaries for each of the documents in the set, the documents received by the system do not need to have any already existing, known summaries. That is, the system generates the data set without having access to any existing summaries.

In some examples, the documents include one or more documents in each of a plurality of natural languages.

For each document, the system processes content from the document using a respective plurality of generative summarization models to generate a plurality of summaries of the document (step 204).

That is, for each document, the system processes the content from the document using multiple different generative summarization models that each generate one or more summaries of the document.

A generative summarization model is a neural network that has been trained to process content from a document to generate a generative summary of the document. A “generative” summary of a document is a summary that is not constrained to consist of content extracted from the document. An “extractive” summary, on the other hand, is one that consists of content extracted from the document.

In some cases, the respective plurality of models are the same across all of the documents, e.g., each document is processed using each model in a set of models.

In some other cases, some documents may be processed by only a subset of the models in the set.

The models in the set of models are generally different in some way, i.e., so that two different models in the set can produce summaries of the same document that have different properties.

For example, some or all of the models can have different architectures, so that different models have different numbers of parameters.

As another example, some or all of the models can have been trained on different sets of training data.

Generating the set of generative summarization models is described in more detail below.

The system can then perform steps 206-210 for each summary of each of the documents.

The system generates an input sequence that includes (i) a natural language instruction to evaluate a consistency of the summary with the document, (ii) the content from the document, and (iii) the summary of the document (step 206).

For example, (i) can precede (ii) and (iii) in the sequence, e.g., “Please evaluate the consistency between the following summary and document,” or can be interspersed among (ii) and (iii) in the sequence, “Please evaluate the consistency of this summary: [summary] with this input document: [document].”

The system processes the input sequence using a language model neural network (LM) to generate an output that rates the consistency of the summary with the document (step 208).

For example, the LM can be a causally-masked, decoder-only Transformer neural network. As a particular example, the neural network can be a large language model neural network (LLM) with a large number of parameters. As particular examples, the LLM can have more than 10 billion parameters, more than 100 billion parameters, or more than 500 billion parameters.

The output can be a score that rates the consistency of the summary with the document.

For example, the score can be a binary score that assigns a first value to being consistent with the document and a second value to being inconsistent with the document. As a particular example, the output can be a score of 1 when the summary is consistent with the document and a score of zero when the summary is not consistent with the document.

For example, the score can be based on the score, e.g., a logit or probability, assigned by the LM to a first predetermined token (e.g., “yes” or “y” or “definitely”) in a vocabulary of tokens for the LM, i.e., to a token that indicates that the LM predicts that the summary is consistent. For example, when the scores are binary, system can assign a score of one to the summary when the sore for the first predetermined token exceeds a threshold value.

As another example, the score can be based on the score, e.g., a logit or probability, assigned by the LM to a second predetermined token (e.g., “no” or “n” or “inconsistent”) in a vocabulary of tokens for the LM, i.e., to a token that indicates that the LM predicts that the summary is not consistent. For example, when the scores are binary, system can assign a score of one to the summary when the sore for the second predetermined token is below a threshold value.

Generally, the language model neural network can have been trained in any of a variety of ways prior to being used to evaluate the consistency of the summaries.

As one example, the language model neural network can have been trained on a language modeling objective, e.g., one that requires predicting the next token in a given training sequence of tokens. Optionally, after having been trained on the language modeling objective, the language model neural network can have been fine-tuned on one or more natural language instruction following objectives, with each of the instruction following objectives measuring how well the language model neural network generates outputs that follow a corresponding natural language instruction.

Advantageously, the language model neural network need not have been fine-tuned or trained on any objective that requires evaluating consistency of summaries with corresponding documents.

That is, the system can make use of the knowledge encoded within the parameters of a language model neural network that has been trained on general training data and general instruction following objectives, without requiring that the language model neural network be trained on the consistency evaluation task. Thus, the system leverages the ability of a large-scale LLM to accurately evaluate the consistency of summaries, even though the large-scale LLM may be too computationally expensive for use for consistency evaluation at run-time.

The system generates a training example that includes the content from the document, the summary of the document, and the output that rates the consistency of the summary with the document (step 210).

Thus, as a result of performing the process 200, for each document in the set of documents, the system has generated a respective training example that rates the consistency of a summary of the document with the document. The system can do this even though no summaries for any of the documents were received as input.

Additionally, as described above, the plurality of documents can include documents in multiple natural languages. Thus, the resulting data set is a multi-lingual data set that evaluates summary consistency of summaries generated in multiple different natural languages.

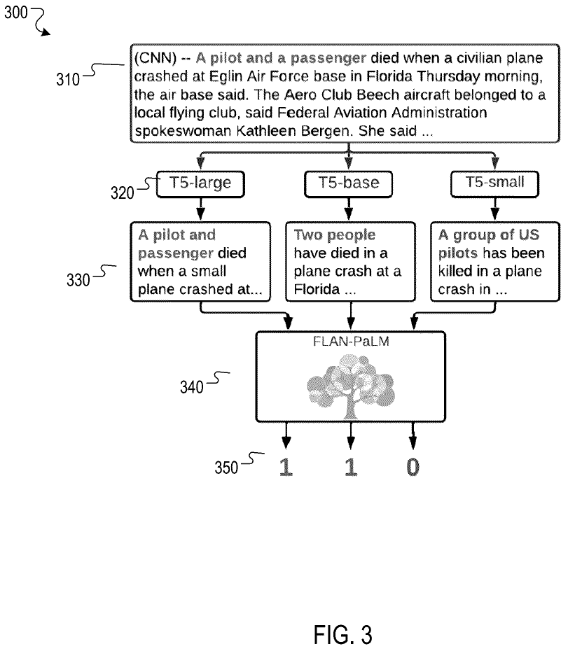

FIG. 3 shows an example 300 of the operation of the system for a given document 310.

As shown in FIG. 3, the system receives the document 310 (in this example, a text document about an airplane crash).

The system processes the content of the document 310 using three different generative document summarization models 320 to generate three different summaries 330 of the document 310. In the example 300, each of the three models 320 is an encoder-decoder Transformer neural network, e.g., having a T5 architecture, and each model has a different number of parameters.

The system then processes the content of the document 310 and each summary 330 using a language model neural network 340 to generate a respective consistency output 350 for each summary 330.

In the example of FIG. 3, the language model neural network 340 is decoder-only Transformer neural network having the Pathways Language Model (PaLM) architecture that has been pre-trained and then fine-tuned on a set of instruction following tasks using the FLAN fine-tuning approach.

Further, in the example of FIG. 3, the consistency outputs 350 are binary scores that take value 1 when the corresponding summary is consistent with the corresponding document and take value 0 when the corresponding summary is not consistent with the corresponding document.

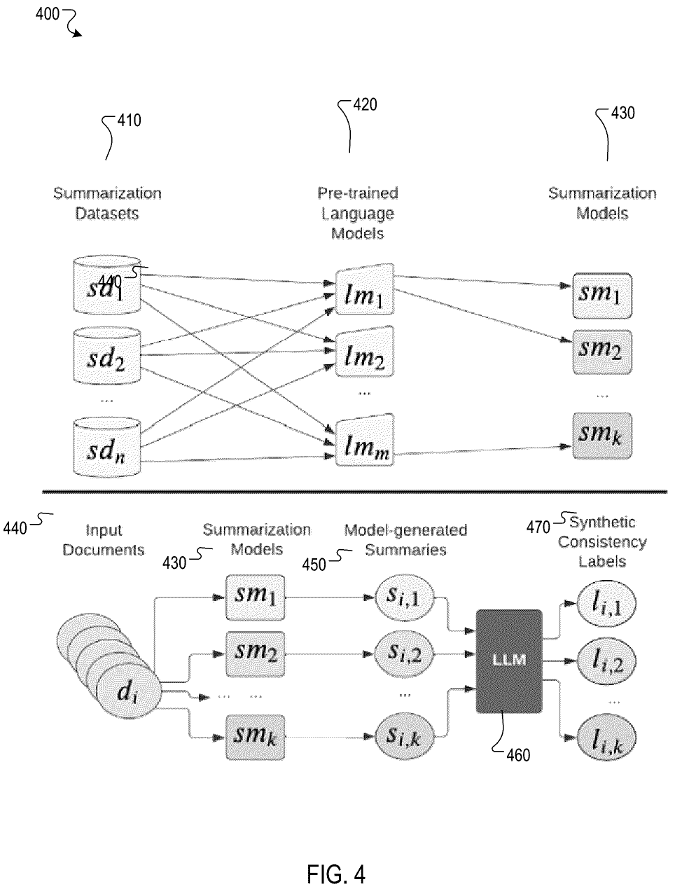

FIG. 4 shows an example 400 of the data generation process performed by the data set generation system.

As shown in the example 400, the system first generates a set of generative summarization models 430.

In particular, the system obtains multiple different summarization datasets 410 and multiple different un-trained generative summarization models 420. Generally, each un-trained generative summarization model 420 has a different number of parameters from the other summarization models 420.

Each summarization data set 410 includes a respective set of training documents and, for each training document in the set, a respective summary of the training document.

The “un-trained” generative summarization models 420 are referred to as “un-trained” because they have not yet been trained to perform the summarization task. In the example 400, each generative summarization model 420 is a different pre-trained language model neural network, e.g., an encoder-decoder Transformer or a decoder-only Transformer. For example, as described above, in one example the models 420 include pre-trained T5-large, T5-base, and T5-small models.

For each un-trained generative summarization model 420, the system trains a respective instance of the un-trained generative summarization model on each of the plurality of training data sets 410 to generate a corresponding trained generative summarization model 430. That is, when there are n data sets 410 and m models 420, the system generates k=nm different trained generative summarization models 430.

While FIG. 4 shows that the datasets 410 are different, in some cases, the system uses only a single summarization dataset 410. Thus, in these cases, there are k=m different trained generative models 430.

After generating the set of generative summarization models 430, the system generates the data set using the set of models 430.

In particular, as described above, the system obtains documents 440, processes each document 440 using at least a subset of the summarization models 430 to generate a set of summaries 450. The system then generates, using an LLM 460, a respective consistency label 470 for each of the generated summaries.

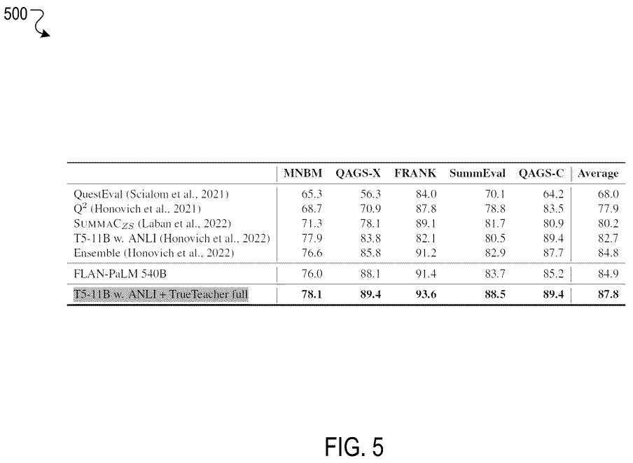

FIG. 5 shows an example 500 of the performance of the described techniques.

In particular, example 500 shows the performance of various techniques measured in ROC-AUC on the summarization subset of the TRUE benchmark. More specifically, example 500 shows the performance of various consistency evaluation models on the summarization subset.

The various techniques include a model with a T5 architecture having 11B parameters (“T5-11B w. ANLI”), a FLAN-PaLM LLM that has 540B parameters and that was used to generate a data set as described above, and the model with the T5 architecture fine-tuned on the data set generated as described above (“T5-11B w. ANLI+TrueTeacher full”).

As can be seen from the example 500, the consistency evaluation model trained on a data set generated as described in this specification significantly outperforms both existing models that have comparable parameter counts and the LLM that was used to generate the training data set, despite having only approximately 2% the parameter count of the LLM. Moreover, the described techniques achieve this performance even though the LLM outperforms the other techniques that have similar compute to the model trained using the described techniques.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining a plurality of documents;
for each document, processing content from the document using a respective plurality of generative summarization models to generate a plurality of summaries of the documents;
for each summary of each of the plurality of documents:
generating a respective input sequence that comprises (i) a natural language instruction to evaluate a consistency of the summary with the document, (ii) the content from the document, and (iii) the summary of the document;
processing the input sequence using a language model neural network to generate an output that rates the consistency of the summary with the document; and
generating a training example that includes the content from the document, the summary of the document, and the output that rates the consistency of the summary with the document.

2. The method of claim 1, further comprising:
training a consistency evaluation neural network on the training examples for the summaries of the plurality of documents, wherein the consistency evaluation neural network is configured to receive an input that comprises content from an input document and an input summary of the input document and generate an output that rates the consistency of the input summary with the input document, and wherein the training comprises, for each training example, using the output that rates the consistency of the summary with the document as a target output for the consistency evaluation neural network.

3. The method of claim 1, wherein the output that rates the consistency of the summary with the document is a score that rates the consistency of the summary with the document.

4. The method of claim 3, wherein the score that rates the consistency of the summary with the document is a binary score that assigns a first value to being consistent with the document and a second value to being inconsistent with the document.

5. The method of claim 1, wherein the language model neural network has been trained on a language modeling objective.

6. The method of claim 5, wherein the language model neural network has been fine-tuned on one or more natural language instruction following objectives.

7. The method of claim 6, wherein the language model neural network has not been fine-tuned or trained on any objective that requires evaluating consistency of summaries with corresponding documents.

8. The method of claim 1, wherein the language model neural network is a large language model neural network that has more than 10 billion parameters.

9. The method of claim 8, wherein the language model neural network has more than 100 billion parameters.

10. The method of claim 9, wherein the language model neural network has more than 500 billion parameters.

11. The method of claim 1, wherein the plurality of documents include one or more documents in each of a plurality of natural languages.

12. The method of claim 1, wherein, for each document, the respective plurality of generative summarization models comprise (i) at least two models that have been trained on different data sets, (ii) at least two models that different numbers of parameters, or (iii) both.

13. The method of claim 1, wherein the respective plurality of generative summarization models for each document comprise at least a subset of generative summarization models in a set of generative summarization models, the method further comprising:
generating the set of generative summarization models, comprising:
obtaining a plurality of training data sets;
obtaining data specifying a plurality of un-trained generative summarization models, each of the un-trained generative summarization models having a different number of parameters; and
for each un-trained generative summarization model, training a respective instance of the un-trained generative summarization model on each of the plurality of training data sets to generate a corresponding trained generative summarization model.

14. The method of claim 1, wherein the respective plurality of generative summarization models for each document are encoder-decoder Transformer neural networks.

15. A system comprising one or more computers and one or more storage devices storing instructions that when executed by the one or more computers cause the one more computers to perform operations comprising:
obtaining a plurality of documents;
for each document, processing content from the document using a respective plurality of generative summarization models to generate a plurality of summaries of the documents;
for each summary of each of the plurality of documents:
generating a respective input sequence that comprises (i) a natural language instruction to evaluate a consistency of the summary with the document, (ii) the content from the document, and (iii) the summary of the document;
processing the input sequence using a language model neural network to generate an output that rates the consistency of the summary with the document; and
generating a training example that includes the content from the document, the summary of the document, and the output that rates the consistency of the summary with the document.

16. The system of claim 15, the operations further comprising:
training a consistency evaluation neural network on the training examples for the summaries of the plurality of documents, wherein the consistency evaluation neural network is configured to receive an input that comprises content from an input document and an input summary of the input document and generate an output that rates the consistency of the input summary with the input document, and wherein the training comprises, for each training example, using the output that rates the consistency of the summary with the document as a target output for the consistency evaluation neural network.

17. The system of claim 15, wherein the output that rates the consistency of the summary with the document is a score that rates the consistency of the summary with the document.

18. The system of claim 17, wherein the score that rates the consistency of the summary with the document is a binary score that assigns a first value to being consistent with the document and a second value to being inconsistent with the document.

19. The system of claim 15, wherein the respective plurality of generative summarization models for each document comprise at least a subset of generative summarization models in a set of generative summarization models, the method further comprising:
generating the set of generative summarization models, comprising:
obtaining a plurality of training data sets;
obtaining data specifying a plurality of un-trained generative summarization models, each of the un-trained generative summarization models having a different number of parameters; and
for each un-trained generative summarization model, training a respective instance of the un-trained generative summarization model on each of the plurality of training data sets to generate a corresponding trained generative summarization model.

20. One or more non-transitory computer storage media storing instructions that when executed by one or more computers cause the one more computers to perform operations comprising:
obtaining a plurality of documents;
for each document, processing content from the document using a respective plurality of generative summarization models to generate a plurality of summaries of the documents;
for each summary of each of the plurality of documents:
generating a respective input sequence that comprises (i) a natural language instruction to evaluate a consistency of the summary with the document, (ii) the content from the document, and (iii) the summary of the document;
processing the input sequence using a language model neural network to generate an output that rates the consistency of the summary with the document; and
generating a training example that includes the content from the document, the summary of the document, and the output that rates the consistency of the summary with the document.
